(19) United States
(12) Patent Application Publication
(10) Pub. No.: US 2010/0314896 A1
(43) Pub. Date: Dec. 16, 2010

(54) CONSOLE FOR A VEHICLE

(75) Inventors: Valter Skibinski, Wallertheim (DE); Alikhan Kuljanov, Wiesbaden (DE); Karim Giordimaina, Ginsheim-Gustavsburg (DE); Min Lee Kyung, Bad Soden am Taunus (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/723,376

(22) Filed: Mar. 12, 2010

(30) Foreign Application Priority Data
Mar. 12, 2009 (DE) 102009012902.2

(51) Int. Cl. B60R 7/04

(52) U.S. Cl. 296/24.34

(57) ABSTRACT

A console is provided for a vehicle, in particular a central console, with a container and at least one storage space that is arranged inside the container, as well as with at least one cover incorporated in the container to close the at least one storage space. In such a console, the container incorporates a first cover and a second cover. The first cover is mounted in the container so that it can pivot around an axis on its side facing away from the second cover and the first cover exhibits a storage space on its side facing the storage space of the container in relation to its closed position. The console ensures that the vehicle passengers in rows of seats arranged one right behind the other in the vehicle are provided with good access to the storage space of the console, without in the process excessively restricting the space conditions in the rear row of seats.

### CROSS-REFERENCE TO RELATED APPLICATION

This application claims priority to German Patent Application No. 102009012902.2, filed Mar. 12, 2009, which is incorporated herein by reference in its entirety.

### TECHNICAL FIELD

The invention relates to a console for a vehicle, in particular a center console, with a container and at least one storage space situated within the container, as well as at least one cover mounted in the container for closing the at least one storage space.

### BACKGROUND

Consoles are often used in vehicles, in particular passenger cars. The consoles are used to hold objects, and additionally most often as an armrest for vehicle passengers seated on either side of the console.

A console of the kind mentioned at the outset is known from DE 20 2006 019 121 U1, for example. In the latter, the container exhibits a single storage space that can be closed by means of a cover. The cover can be pivoted relative to the orientation of the console in the vehicle around an axis located at the back end of the container, and is locked at the front with the container. A handle can be used to release the lock. This console can be shifted in a rail system located in the longitudinal direction of the vehicle, between a front end position adjacent to the dashboard of the vehicle and a back end position into which it extends up to behind the driver's seat or front seat passenger's seat.

The position of the cover and its hinged mounting in the rear area of the container make it difficult if not impossible for the persons situated in the second row of seats of the vehicle to access the storage space of the console. In addition, the cover only functions as a cover element.

A console of the kind mentioned at the outset is further described in DE 199 56 366 A1. In the latter, the single cover can also be pivoted around a rear axis of the container, in an essentially horizontal final pivoted position, as a result of which the relatively large cover extends into the area of the vehicle passengers in the second row of seats. This produces a relatively large storage space between the driver's seat and the front passenger's seat, which is accessible to the vehicle passengers in the first row of seats. In relation to its closed position, the cover is provided with a storage space on its side facing the storage space of the container. With the cover flipped open, objects can hence be placed in this storage space of the cover, in particular by vehicle passengers in the second row of seats. In addition, the cover incorporates a plate that can be retracted laterally, meaning toward the pivoting axis of the cover. This plate exhibits two circular openings that accommodate receptacles, in particular receptacles designed as drinking vessels.

The disadvantage to this console is that, since the length of the cover corresponds to the length of the container, the cover extends very far into the area of the second row of seats when it is in its deployed end position, taking up a considerable amount of space between the vehicle passengers sitting to the right and left inside the vehicle in the second row of seats on the one hand, and leaving insufficient room for a person to be situated on the middle seat between these persons on the other.

DE 84 18 140 U1, DE 31 43 957 A1 and EP 0 593 169 A1 describe consoles for vehicles in which a pivoting motion can open up free access to means for holding one or more receptacles, in particular a bottle, can, cup or the like.

At least one object of the present invention is to further develop a console of the kind mentioned at the outset in such a way as to provide the vehicle passengers in rows of seats arranged one right behind the other with good access to the storage space of the console, without in the process excessively restricting the space conditions in the area of the rear row of seats. In addition, other objects, desirable features, and characteristics will become apparent from the subsequent summary and detailed description of the invention and the appended claims, taken in conjunction with the accompanying drawings and this background.

### SUMMARY

The at least one object, other objects, desirable features, and characteristics, are achieved by securing a first and second cover in the container, wherein the first cover is mounted in the container so that it can pivot around an axis on its side facing away form the second cover, and wherein the first cover exhibits a storage space on its side facing the storage space of the container in relation to its closed position.

As a result, the first cover is readily accessible to the vehicle passengers situated in the rear row of seats, wherein mounting the first cover in the rear area of the console yields a situation in which the first cover is pivoted toward the rear row of seats, meaning toward the vehicle passengers present there. Since the container can be closed by means of the first and second cover, the first cover only extends over a partial length of the console, so that this cover only extends into the area of the rear row of seats over a partial length of the console from the pivoting axis of the first cover. Due to the readily accessible storage space of the cover, the then upper side of the first cover offers a preferred tray for the vehicle passengers in the rear row of seats in their immediate vicinity. In addition, a further partial storage area of the container is freely accessible for these vehicle passengers in front of the flipped-back cover, thereby making two different storage spaces available for use by the vehicle passengers in the rear row of seats.

The front, second cover can be operated independently of the first cover, and is located in the area of the console situated between the vehicle passengers in the first row of seats, meaning the driver's seat and front passenger's seat. From this standpoint, it is regarded as advantageous if the first cover can be pivoted around an axis arranged at the rear end of the container, and the second cover can be pivoted around an axis adjacent to the first cover in relation to the closed position of the first cover. Both covers can preferably be locked in their closed position, wherein a handle is provided on the side of the respective handle facing away from its pivoting axis to release said cover.

At least the second cover, and in particular both covers, is/are provided with padding on its/their surface. This makes the console exquisitely suited as an armrest for the driver or front seat passenger.

It is regarded as especially advantageous to arrange the first cover in an essentially horizontal manner in its flipped-open position. This cover should here be locked in place, in particular by contacting the container at a distance away from its pivoting axis. The container hence represents the stop for the first cover in this flipped-open position. This flat abutment makes it possible to accommodate objects that are relatively heavy in the storage space of the first cover. As a consequence, it is not necessary to accommodate these objects in the storage space of the container.

In a special embodiment of the invention, it is provided that at least one means for holding the receptacle, in particular a bottle, can, cup or the like, be secured in the first cover. As a result, this configuration for the console according to the invention makes it possible to perform the function of a cup holder in particular. The at least one means for holding a receptacle is preferably situated to the side of the cover; in particular, each of the two sides of the cover is provided with a means for holding a receptacle. The respective means for holding a receptacle is best laterally retractable from the cover, meaning toward the pivoting axis of the first cover in the container, so as to accommodate the receptacle. As a result, no additional interior space in the longitudinal direction of the vehicle is required to implement the cup holder function, wherein the respective means rather takes up an additional area of the vehicle interior in terms of its width.

In a special configuration, it is provided that the container accommodates two storage spaces, wherein the one storage space can be covered by the first cover, and the other storage space can be covered by the second cover. The first cover extends in the longitudinal direction of the vehicle, in particular over about ⅓ the length of the receptacle, so that the second cover extends over roughly about ⅔ of the length of the receptacle. Given the corresponding arrangement of the two storage spaces, about the same overall storage space is available to the vehicle passengers situated in the front of the vehicle and the passengers sitting in the row of seats behind in terms of the usable storage space of the first cover.

In a special embodiment of the invention, it is provided that the console is movably mounted on rails arranged in the longitudinal direction of the vehicle. This makes it possible to shift the console out of a central position toward the front or back. If the console is shifted far enough to the front, the storage space of the first cover and the storage space of the container allocated to the first cover is also readily accessible to vehicle passengers situated in the front row of seats. If the middle seat of the rear row of seats is no occupied, it may be best to push the console far to the back on the rails, so that the rear area of the console is especially readily accessible to the back seat passengers.

### BRIEF DESCRIPTION OF THE DRAWINGS

The present invention will hereinafter be described in conjunction with the following drawing figures, wherein like numerals denote like elements, and:

FIG. 1 is a spatial view of the interior space of a passenger car, which incorporates the console according to the invention, illustrated with the console in the central position on a rail system for accommodating the console;

FIG. 2 is the arrangement according to FIG. 1 with the console pushed toward the back, with a first cover in the open position; and

FIG. 3 is the arrangement according to FIG. 2, with means for holding receptacles to realize the cup holder function additionally retracted form the first cover.

### DETAILED DESCRIPTION

The following detailed description is merely exemplary in nature and is not intended to limit application and uses. Furthermore, there is no intention to be bound by any theory presented in the preceding background or summary the following detailed description.

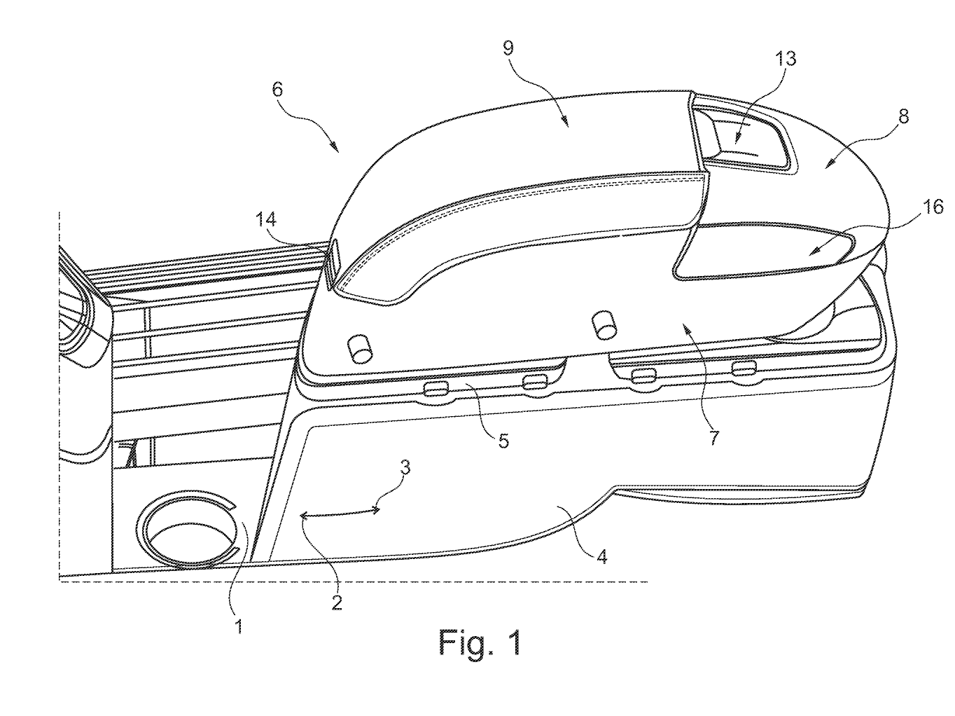

FIG. 1 illustrates the interior space of a passenger car in the area of a central tunnel 1 between a driver's seat and front passenger seat of the vehicle (not shown). The longitudinal direction of the vehicle is denoted by a double arrow with the arrow points 2 and 3, wherein arrow 2 is pointing to the front, and arrow 3 is pointing to the back. In relation to the direction of travel according to arrow 2, this yields the orientations “right” and “left”, “front” and “back” in the vehicle.

Located between the driver's seat and front passenger seat is a box-shaped central portion 4, which is provided on top with two mutually parallel rails 5 oriented in the longitudinal direction of the vehicle. The console 6 according to the invention can slide along these rails, and can be fixed in place at various settings in the longitudinal direction of the vehicle by means of latching units (not shown in any greater detail).

Console 6 has a container 7, which is mounted on the rails 5, along with two covers secured in the container 7, wherein the rear cover 8 is labeled as the first cover, and the front cover 9 is labeled as the second cover. Cover 8 extends over roughly ⅓ the length of the console 6, and cover 9 extends over roughly ⅔ of the length of the console 6. The container 7 accommodates two storage spaces. In relation to the closed position of the covers 8 and 9, a storage space is located under the respective cover 8 or 9 in the container. The storage space of the container 7 allocated to the first cover 8 is marked with reference number 10. The other storage space of the container 7 is situated before the latter, separated by a wall.

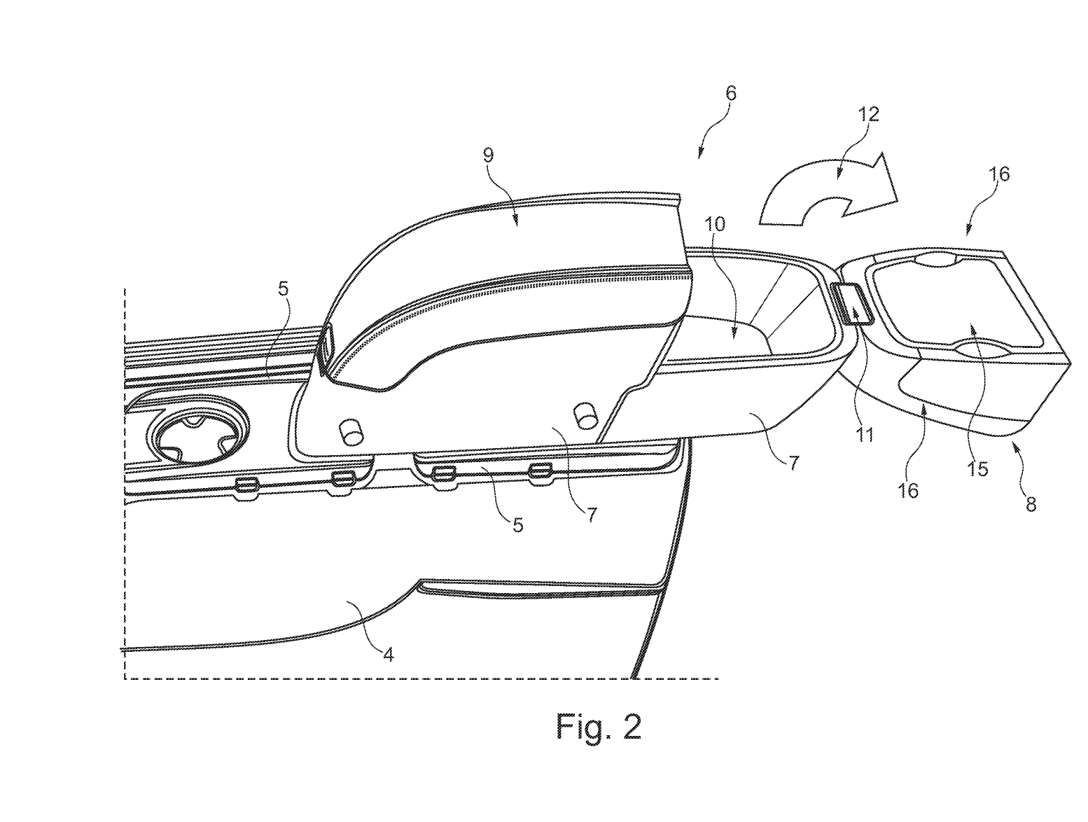

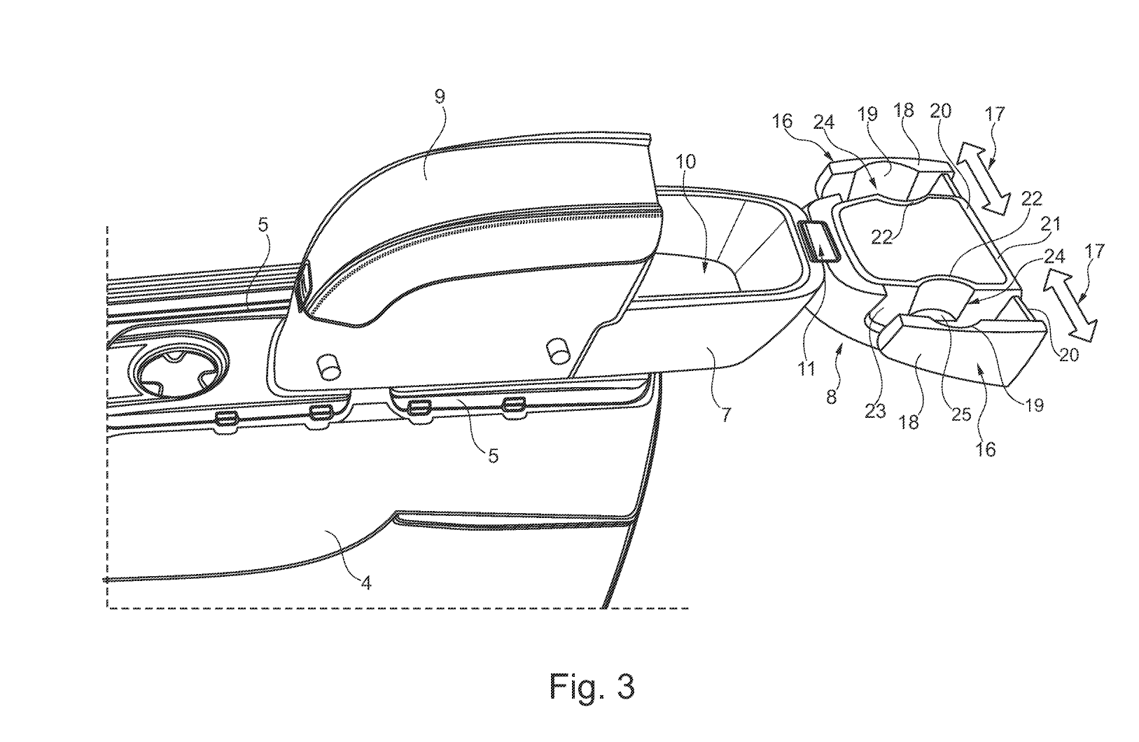

In the rear area of the container 7, the cover 8 is mounted in the container around an axis 11 situated transverse to the longitudinal extension of the vehicle, and the cover 8 flatly abuts the rear wall of the container 7 in its flipped-open, horizontally position illustrated on FIGS. 2 and 3. This yields a stop setting for the cover 8 in the flipped-open position. The arrow 12 denotes direction in which the cover 8 flips open. The cover 8 is opened using a handle 13, which interacts with a latching mechanism (not shown) in order to lock the cover 8 with the container 7 in the closed position of the cover 8 shown on FIG. 1.

In the area of its rear end, the cover 9 is mounted in the container 7 so that it can pivot around an axis (not shown). In the front area, the cover 9 is provided with a handle 14, which interacts with latching elements that effect a latching of the cover 9 in the area of its front end with the are of the container 7 located there. When flipped open, the cover 9 is essentially oriented perpendicular in relation to the section adjacent to its pivoting axis.

FIG. 2 and FIG. 3 show the console in a final position shifted toward the back on the rails 5. In this position, the rear end of the console 6 projects over the rear end of the central portion 4, meaning into the area behind the first row of seats. As a result, the console 6 is readily accessible to vehicle passengers in the second row of seats.

As can be gleaned from FIG. 2 and FIG. 3, the cover 8 is provided on its side facing the storage space 10 with its own storage space 15 in relation to its closed position. This storage space 15 is designed as a trough in the cover 8. Because the cover 8 is mounted in the container 7 and a stop is formed between the parts, the storage space 15 of the cover 8 is more than able to accommodate relatively heavy objects.

A means 16 for holding a receptacle is accommodated on the right and left side of the cover 8, in the cover 8. This receptacle can be a bottle, jar, cup or the like. This respective means 16 can be refracted and inserted into and from the cover 8 as denoted by arrows 17. The respective means 16 exhibits a mounting plate 18 with a recess 19, along with a plate-shaped rear bearing insert 20, which is movably held in a depression of the rear wall section 21 of the cover 8. Accordingly, the cover 8 is provided with a recess 22 on its side facing the respective mounting plate 18. With the mounting plate 18 pulled out, a retainer 24 for a receptacle with a circular cross section (not shown) is formed between the mounting plate and the wall section 23 exhibiting the recess 22. To prevent the receptacle placed in the retainer 24 from slipping downward, the respective wall section 23 is provided below with a horizontal projecting support 25, and the mounting plate 18 is correspondingly provided with a projecting support (not shown). The container rests upon these two projecting supports.

As a result, the configuration of the console according to the invention provides additional storage space and a cup holder in the second row of seats. The unlatching means in the middle allows the vehicle passenger in the second row of seats to rotate the rear, upper section—cover 8—of the armrest formed by the two covers 8 and 9 toward him or herself. This results in two trays, storage spaces 10 and 15. In addition, the cup holder function is realized on both sides with the cover 8 flipped open, and means 16 laterally retracted. The structural design of the console according to the invention is robust and simple.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A console for a vehicle, comprising:
a container;
at least one storage space arranged inside the container;
at least one cover mounted in the container and adapted to close the at least one storage space;
a first cover is mounted in the container and adapted to pivot around an axis on a side facing away from a second cover; and
a storage space on a side of the first cover that faces the storage space of the container in relation to a closed position.

2. The console according to claim 1, wherein the first cover is adapted to pivot around an axis arranged at a rear end of the container in relation to an orientation of the console in the vehicle.

3. The console according to claim 1, wherein the second cover is adapted to pivot around an axis arranged adjacent to the first cover in relation to the closed position of the first cover.

4. The console according to claim 1, wherein the first cover is adapted to lock with the container in relation to a container closed position adjacent to the second cover, and comprises a handle adapted to unlock the first cover adjacent to the second cover.

5. The console according to claim 1, wherein the second cover comprises padding on an upper surface.

6. The console according to claim 1, wherein the first cover and the second cover comprises padding on an upper surface.

7. The console according to claim 1, wherein the first cover and the second cover comprise padding on an upper surface.

8. The console according to claim 1, wherein the first cover is arranged essentially horizontally in a flipped open position.

9. The console according to claim 1, wherein the first cover is locked in a flipped-open position and the first cover is adapted to contact the container at a distance away from a pivoting axis.

10. The console according to claims 1, wherein the first cover is adapted to accommodate at least one holding receptacle.

11. The console according to claim 10, wherein the at least one holding receptacle is arranged to a side of the at least one cover.

12. The console according to claim 11, wherein the at least one holding receptacle can be retracted laterally from the at least one cover.

13. The console according to claim 1, wherein the container is adapted to incorporate a first storage space and a second storage space, wherein the first storage space can be covered by the first cover, and the second storage space can be covered by the second cover.

14. The console according to claim 1, wherein the console is arranged between a first seat and a second seat in a first seat row, and the first cover is adapted to pivot into and area of a second seat row of the vehicle.

15. The console according to claim 14, wherein the console the first seat is a driver seat.

16. The console according to claim 14, wherein the console the second seat is a passenger seat.

17. The console according to claim 1, wherein the console is mounted for movement on a rail and arranged in a longitudinal direction of the vehicle.
